(19) United States
(12) Patent Application Publication
(10) Pub. No.: US 2016/0276747 A1
(43) Pub. Date: Sep. 22, 2016

(54) METHOD AND APPARATUS FOR SATELLITE USER TERMINAL ANTENNA POINTING

(71) Applicant: QUALCOMM Incorporated, San Diego, CA (US)

(72) Inventors: Roy Howard Davis, Del Mar, CA (US); Ernest Tadashi Ozaki, Poway, CA (US)

(21) Appl. No.: 14/857,530

(22) Filed: Sep. 17, 2015

Related U.S. Application Data
(60) Provisional application No. 62/136,234, filed on Mar. 20, 2015.

(51) Int. Cl. H01Q 3/14; H01Q 15/08

(52) U.S. Cl. CPC H01Q 3/14; H01Q 15/08

(57) ABSTRACT

Disclosed is an antenna including a lens; a feed trolley configured to couple to a feed; a track coupled to the feed trolley; a flexible member connected to the feed trolley configured to move the feed coupled to the feed trolley along the track to a first destination or to a second destination, wherein the feed is configured to move along the track to the first destination to form a first collimated beam through the lens to point to a first satellite, and wherein the feed is configured to move along the track to the second destination to form a second collimated beam through the lens to point to a second satellite. In various examples, the antenna includes a second feed trolley and a second feed, and the track includes two sides to accommodate a feed trolley on each side.

### CLAIM OF PRIORITY UNDER 35 U.S.C. §119

The present application for patent claims priority to Provisional Application No. 62/136,234 entitled “Satellite User Terminal Antenna” filed Mar. 20, 2015, and assigned to the assignee hereof and hereby expressly incorporated by reference herein.

### INTRODUCTION

Various aspects described herein relate to satellite communications, and more particularly, to a method and apparatus for satellite user terminal antenna pointing with different degrees of freedom.

Conventional satellite-based communication systems include gateways and one or more satellites to relay communication signals between the gateways and one or more user terminals (UTs). A gateway is an earth station having an antenna for transmitting signals to, and receiving signals from, communication satellites. A gateway provides communication links, using satellites, for connecting a user terminal (UT) to other user terminals or users of other communication systems, such as a public switched telephone network, the internet and various public and/or private networks. A satellite is an orbiting receiver and repeater used to relay information.

A satellite may receive signals from and transmit signals to a user terminal provided the user terminal is within the “footprint” of the satellite. The footprint of a satellite is the geographic region on the surface of the Earth within the range of signals of the satellite. The footprint is usually geographically divided into “beams,” through the use of one or more antennas. Each beam covers a particular geographic region within the footprint. Beams may be directed so that more than one beam from the same satellite covers the same specific geographic region.

Geosynchronous satellites have long been used for communications. A geosynchronous satellite is stationary or nearly stationary relative to a given location on the Earth, and thus there is little timing shift and frequency shift in radio signal propagation between a communication transceiver on the Earth and the geosynchronous satellite. However, because geosynchronous satellites are limited to a geosynchronous orbit (GSO), the number of satellites that may be placed in the GSO is limited. As alternatives to geosynchronous satellites, communication systems which utilize a constellation of satellites in non-geosynchronous orbits, such as low-earth orbits (LEO), have been devised to provide communication coverage to the entire Earth or at least large parts of the Earth.

Compared to GSO satellite-based and terrestrial communication systems, non-geosynchronous satellite-based systems, such as LEO satellite-based systems, may present several challenges. A characteristic of the LEO satellites is that they move across the sky such that a single satellite is in a position to be used for a few minutes before service will have to be switched to a second satellite. To access the satellites from a user terminal with adequate signal strength requires pointing a high-gain beam at the satellites. To provide continuous service requires switching from pointing the high-gain beam at a first satellite to pointing the high-gain beam at a second satellite rapidly as the first satellite goes out of view, and as the second satellite goes out of view, switching to a third satellite is needed. This is essentially a continuous process, and accordingly, efficient and reliable handover mechanisms are highly desirable in the field of satellite communications.

### SUMMARY

Aspects of the disclosure are directed to apparatus and methods for satellite user terminal antenna pointing with different degrees of freedom.

According to various aspects, disclosed is an antenna including a lens; a first feed trolley configured to couple to a first feed, wherein the first feed is configured to form a first collimated beam through the lens in a first direction; a second feed trolley configured to couple to a second feed, wherein the second feed is configured to form a second collimated beam through the lens in a second direction; a track coupled to the first feed trolley and the second feed trolley, wherein the first feed coupled to the first feed trolley is configured to move along the track to a first destination to form the first collimated beam through the lens in the first direction and the second feed coupled to the second feed trolley is configured to move along the track to a second destination to form the second collimated beam through the lens in the second direction; and a first flexible member connected to the first feed trolley configured to move the first feed coupled to the first feed trolley along the track, and a second flexible member connected to the second feed trolley configured to move the second feed coupled to the second feed trolley along the track.

According to various aspects, disclosed is an antenna including a lens; a feed trolley configured to couple to a feed; a track coupled to the feed trolley; a flexible member connected to the feed trolley configured to move the feed coupled to the feed trolley along the track to a first destination or to a second destination, wherein the feed is configured to move along the track to the first destination to form a first collimated beam through the lens to point to a first satellite, and wherein the feed is configured to move along the track to the second destination to form a second collimated beam through the lens to point to a second satellite.

### BRIEF DESCRIPTION OF THE DRAWINGS

The accompanying drawings are presented to aid in the description of aspects of the disclosure and are provided solely for illustration of the aspects and not limitations thereof.

FIG. 1 is a block diagram of an example communication system.

FIG. 2 is a block diagram of one example of the gateway of FIG. 1.

FIG. 3 is a block diagram of one example of the satellite of FIG. 1.

FIG. 4 is a block diagram of one example of the User Terminal of FIG. 1.

FIG. 5 is a block diagram of one example of the User Equipment of FIG. 1.

FIG. 6 is a first diagram illustrating the focusing property of a Luneburg lens.

FIG. 7 is a second diagram illustrating the focusing property of a Luneburg lens.

FIG. 8 is a diagram illustrating an example antenna with a single feed.

FIG. 9 is a diagram illustrating an example of a track with a feed trolley in a cross sectional view.

FIG. 10 is a diagram illustrating an example antenna with a two feeds.

FIG. 11 is a diagram illustrating an example antenna with two feeds and two moving feed trolleys.

FIG. 12 is a diagram illustrating an example antenna with a two feeds and possessing three degrees of freedom.

FIG. 13 is a block diagram illustrating an example of an apparatus employing a processing circuit that may be adapted according to certain aspects disclosed herein.

Like reference numerals refer to corresponding parts throughout the drawing figures.

### DETAILED DESCRIPTION

Aspects of the disclosure are described in the following description and related drawings directed to specific examples. Alternate examples may be devised without departing from the scope of the disclosure. Additionally, well-known elements will not be described in detail or will be omitted so as not to obscure the relevant details of the disclosure.

The word “exemplary” is used herein to mean “serving as an example, instance, or illustration.” Any aspect described herein as “exemplary” is not necessarily to be construed as preferred or advantageous over other aspects. Likewise, the term “aspects” does not require that all aspects include the discussed feature, advantage or mode of operation.

The terminology used herein is for the purpose of describing particular aspects only and is not intended to be limiting of the aspects. As used herein, the singular forms “a,” “an” and “the” are intended to include the plural forms as well, unless the context clearly indicates otherwise. It will be further understood that the terms “comprises,” “comprising,” “includes” or “including,” when used herein, specify the presence of stated features, integers, steps, operations, elements, or components, but do not preclude the presence or addition of one or more other features, integers, steps, operations, elements, components, or groups thereof. Moreover, it is understood that the word “or” has the same meaning as the Boolean operator “OR,” that is, it encompasses the possibilities of “either” and “both” and is not limited to “exclusive or” (“XOR”), unless expressly stated otherwise. It is also understood that the symbol “I” between two adjacent words has the same meaning as “or” unless expressly stated otherwise. Moreover, phrases such as “connected to,” “coupled to” or “in communication with” are not limited to direct connections unless expressly stated otherwise.

Further, many aspects are described in terms of sequences of actions to be performed by, for example, elements of a computing device. It will be recognized that various actions described herein may be performed by specific circuits, for example, central processing units (CPUs), graphic processing units (GPUs), digital signal processors (DSPs), application specific integrated circuits (ASICs), field programmable gate arrays (FPGAs), or various other types of general purpose or special purpose processors or circuits, by program instructions being executed by one or more processors, or by a combination of both. Additionally, these sequence of actions described herein may be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

In the following description, numerous specific details are set forth such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the various aspects of the present disclosure. In other instances, well-known circuits and devices are shown in block diagram form to avoid obscuring the present disclosure. The various aspects of the present disclosure are not to be construed as limited to specific examples described herein but rather to include within their scopes all implementations defined by the appended claims.

Disclosed herein is an antenna that enables positioning of one or two feeds for handovers. This structure allows continuous (or substantially continuous) communication with a satellite network. Each feed is coupled to a feed trolley. The antenna may include a Luneburg lens for focusing a plane wave incident on one side of the lens to a point on the opposite side of the lens.

The antenna may include a vertical shaft with bearings for smooth rotation about a vertical axis. Structural support and rotation may be provided by the vertical shaft. In various examples, the rotation around the vertical axis moves the antenna beam in the azimuth direction. An azimuth drive motor is mounted on the base of the antenna and rotates the vertical shaft and the rest of the antenna. The azimuth drive motor provides a first degree of freedom. The azimuth drive motor may be a stepper motor, servo motor or any other type of motor where the speed and position of the motor shaft may be controlled. The coupling mechanism between the azimuth drive motor and the vertical shaft may be a toothed belt, V-belt, chain, cable or any other type of drive coupling including direct drive from the motor shaft.

The one or two feed trolleys ride on a track. In various examples, the track is in the shape of a half-circle or other suitable portion of an arc or curved shape. The one or two feed trolleys move along the track such that at least one of the feeds is always pointed at the center of the lens. The feed trolley may ride on wheels or bearings that run on the track. The one or two feed trolleys may be moved along the track by an elevation drive motor. The elevation drive motor provides a second degree of freedom. A tilt mechanism may be included to provide a third degree of freedom, which is to tilt the antenna. The third degree of freedom allows each of the antenna beams from each of the one or two feeds to be pointed in arbitrary directions. The antenna enables aiming of two antenna beams to two satellites. This way, with both antenna beams aimed at a source satellite and at a target satellite, a handover from the source satellite to the target satellite may be undertaken.

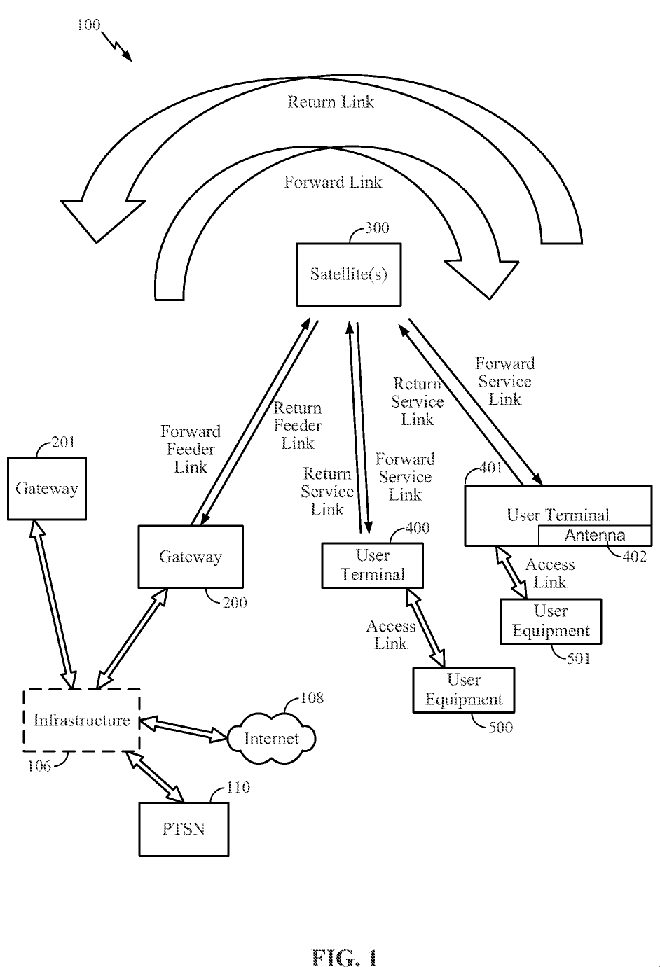

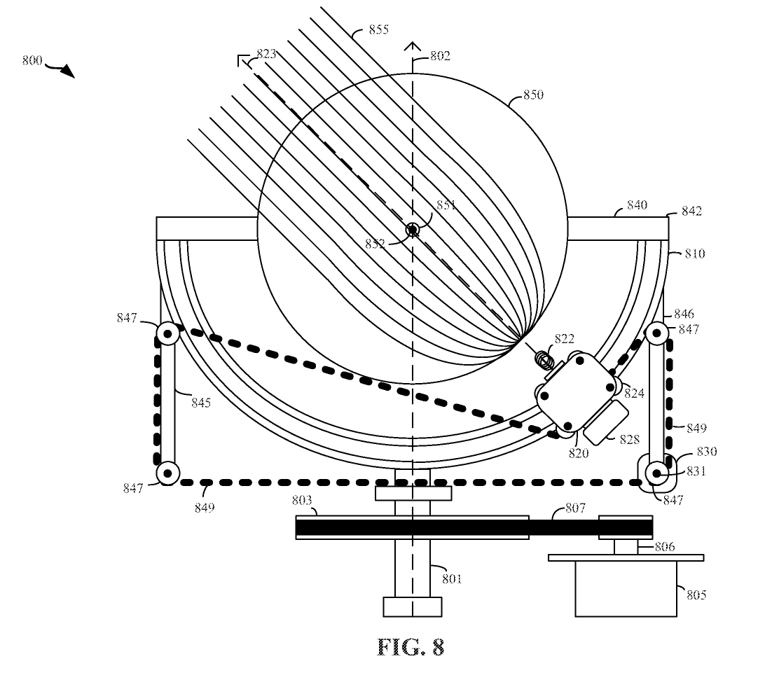

FIG. 1 illustrates an example of a satellite communication system 100 which includes a plurality of satellites (although only one satellite 300 is shown for clarity of illustration) in non-geosynchronous orbits, for example, low-earth orbits (LEO), a gateway 200 in communication with the satellite 300, a plurality of user terminals (UTs) 400 and 401 in communication with the satellite 300, and a plurality of user equipment (UE) 500 and 501 in communication with the UTs 400 and 401, respectively. In various aspects, the UTs 400, 401 may include an antenna 402 similar to those disclosed in FIGS. 8 and 10-12. Although only UT 401 is shown with the antenna 402, UT 400 may also include such an antenna. And, although not shown, in various examples, one or more of the gateways 200, 201 and/or one or more of the UEs 500, 501 may be implemented with the antenna 402. Each UE 500 or 501 may be a user device such as a mobile device, a telephone, a smartphone, a tablet, a laptop computer, a computer, a wearable device, a smart watch, an audiovisual device, or any device including the capability to communicate with a UT. Additionally, the UE 500 and/or UE 501 may be a device (e.g., access point, small cell, etc.) that is used to communicate to one or more end user devices. In the example illustrated in FIG. 1, the UT 400 and the UE 500 communicate with each other via a bidirectional access link (having a forward access link and return access link), and similarly, the UT 401 and the UE 501 communicate with each other via another bidirectional access link. In another implementation, one or more additional UE (not shown) may be configured to receive only and therefore communicate with a UT only using a forward access link. In another implementation, one or more additional UE (not shown) may also communicate with UT 400 or UT 401. Alternatively, a UT and a corresponding UE may be integral parts of a single physical device, such as a mobile telephone with an integral satellite transceiver and an antenna for communicating directly with a satellite, for example.

The gateway 200 may have access to the Internet 108 or one or more other types of public, semiprivate or private networks. In the example illustrated in FIG. 1, the gateway 200 is in communication with infrastructure 106, which is capable of accessing the Internet 108 or one or more other types of public, semiprivate or private networks. The gateway 200 may also be coupled to various types of communication backhaul, including, for example, landline networks such as optical fiber networks or public switched telephone networks (PSTN) 110. Further, in alternative implementations the gateway 200 may interface to the Internet 108, PSTN 110, or one or more other types of public, semiprivate or private networks without using infrastructure 106. Still further, gateway 200 may communicate with other gateways, such as gateway 201 through the infrastructure 106 or alternatively may be configured to communicate to gateway 201 without using infrastructure 106 Infrastructure 106 may include, in whole or part, a network control center (NCC), a satellite control center (SCC), a wired and/or wireless core network and/or any other components or systems used to facilitate operation of and/or communication with the satellite communication system 100.

Communications between the satellite 300 and the gateway 200 in both directions are called feeder links, whereas communications between the satellite and each of the UTs 400 and 401 in both directions are called service links. A signal path from the satellite 300 to a ground station, which may be the gateway 200 or one of the UTs 400 and 401, may be generically called a downlink. A signal path from a ground station to the satellite 300 may be generically called an uplink. Additionally, as illustrated, signals may have a general directionality such as a forward link and a return link or reverse link. Accordingly, a communication link in a direction originating from the gateway 200 and terminating at the UT 400 through the satellite 300 is called a forward link, whereas a communication link in a direction originating from the UT 400 and terminating at the gateway 200 through the satellite 300 is called a return link or reverse link. As such, the signal path from the gateway 200 to the satellite 300 is labeled “Forward Feeder Link” whereas the signal path from the satellite 300 to the gateway 200 is labeled “Return Feeder Link” in FIG. 1. In a similar manner, the signal path from each UT 400 or 401 to the satellite 300 is labeled “Return Service Link” whereas the signal path from the satellite 300 to each UT 400 or 401 is labeled “Forward Service Link” in FIG. 1.

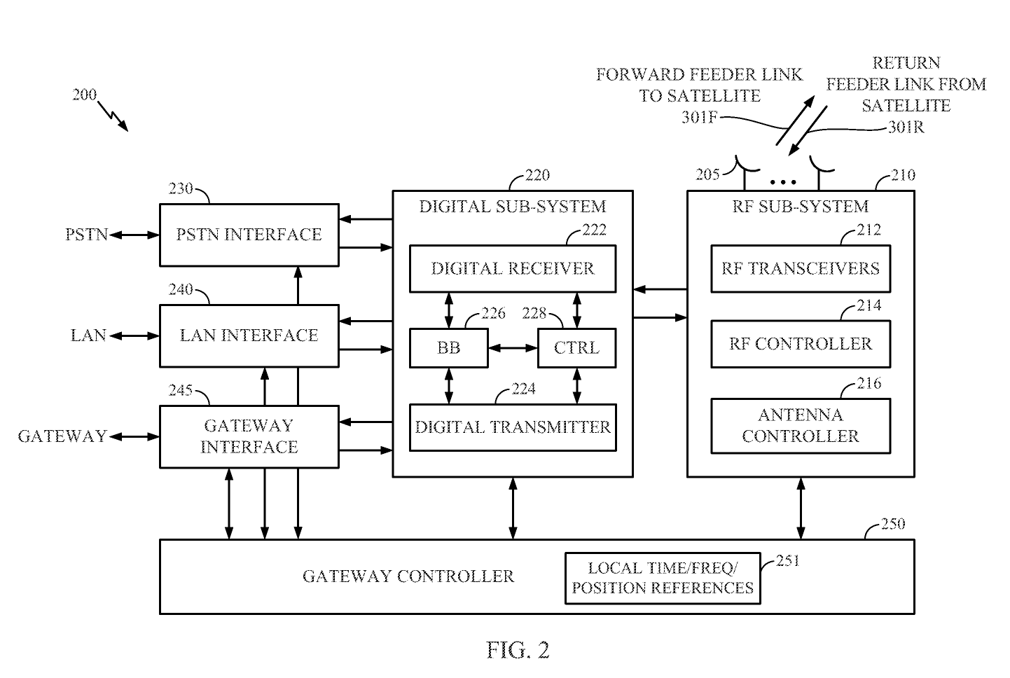

FIG. 2 is an example block diagram of gateway 200, which may also be applied to gateway 201 of FIG. 1. Gateway 200 is shown to include a number of antennas 205, an RF subsystem 210, a digital subsystem 220, a Public Switched Telephone Network (PSTN) interface 230, a Local Area Network (LAN) interface 240, a gateway interface 245, and a gateway controller 250. RF subsystem 210 is coupled to antennas 205 and to digital subsystem 220. Digital subsystem 220 is coupled to PSTN interface 230, to LAN interface 240, and to gateway interface 245. Gateway controller 250 is coupled to RF subsystem 210, digital subsystem 220, PSTN interface 230, LAN interface 240, and gateway interface 245.

RF subsystem 210, which may include a number of RF transceivers 212, an RF controller 214, and an antenna controller 216, may transmit communication signals to satellite 300 via a forward feeder link 301F, and may receive communication signals from satellite 300 via a return feeder link 301R. Although not shown for simplicity, each of the RF transceivers 212 may include a transmit chain and a receive chain. Each receive chain may include a low noise amplifier (LNA) and a down-converter (e.g., a mixer) to amplify and down-convert, respectively, received communication signals in a well-known manner. In addition, each receive chain may include an analog-to-digital converter (ADC) to convert the received communication signals from analog signals to digital signals (e.g., for processing by digital subsystem 220). Each transmit chain may include an up-converter (e.g., a mixer) and a power amplifier (PA) to up-convert and amplify, respectively, communication signals to be transmitted to satellite 300 in a well-known manner. In addition, each transmit chain may include a digital-to-analog converter (DAC) to convert the digital signals received from digital subsystem 220 to analog signals to be transmitted to satellite 300.

The RF controller 214 may be used to control various aspects of the number of RF transceivers 212 (e.g., selection of the carrier frequency, frequency and phase calibration, gain settings, and the like). The antenna controller 216 may control various aspects of the antennas 205 (e.g., beamforming, beam steering, gain settings, frequency tuning, and the like).

The digital subsystem 220 may include a number of digital receiver modules 222, a number of digital transmitter modules 224, a baseband (BB) processor 226, and a control (CTRL) processor 228. Digital subsystem 220 may process communication signals received from RF subsystem 210 and forward the processed communication signals to PSTN interface 230 and/or LAN interface 240, and may process communication signals received from PSTN interface 230 and/or LAN interface 240 and forward the processed communication signals to RF subsystem 210.

Each digital receiver module 222 may correspond to signal processing elements used to manage communications between gateway 200 and UT 400. One of the receive chains of RF transceivers 212 may provide input signals to multiple digital receiver modules 222. A number of digital receiver modules 222 may be used to accommodate all of the satellite beams and possible diversity mode signals being handled at any given time. Although not shown for simplicity, each digital receiver module 222 may include one or more digital data receivers, a searcher receiver, and a diversity combiner and decoder circuit. The searcher receiver may be used to search for appropriate diversity modes of carrier signals, and may be used to search for pilot signals (or other relatively fixed pattern strong signals).

The digital transmitter modules 224 may process signals to be transmitted to UT 400 via satellite 300. Although not shown for simplicity, each digital transmitter module 224 may include a transmit modulator that modulates data for transmission. The transmission power of each transmit modulator may be controlled by a corresponding digital transmit power controller (not shown for simplicity) that may (1) apply a minimum level of power for purposes of interference reduction and resource allocation and (2) apply appropriate levels of power when needed to compensate for attenuation in the transmission path and other path transfer characteristics.

The control processor 228, which is coupled to digital receiver modules 222, digital transmitter modules 224, and baseband processor 226, may provide command and control signals to effect functions such as, but not limited to, signal processing, timing signal generation, power control, handoff control, diversity combining, and system interfacing.

The control processor 228 may also control the generation and power of pilot, synchronization, and paging channel signals and their coupling to the transmit power controller (not shown for simplicity). The pilot channel is a signal that is not modulated by data, and may use a repetitive unchanging pattern or non-varying frame structure type (pattern) or tone type input. For example, the orthogonal function used to form the channel for the pilot signal generally has a constant value, such as all 1's or 0's, or a well-known repetitive pattern, such as a structured pattern of interspersed 1's and 0's.

Baseband processor 226 is well known in the art and is therefore not described in detail herein. For example, the baseband processor 226 may include a variety of known elements such as (but not limited to) coders, data modems, and digital data switching and storage components.

The PSTN interface 230 may provide communication signals to, and receive communication signals from, an external PSTN either directly or through additional infrastructure 106, as illustrated in FIG. 1. The PSTN interface 230 is well known in the art, and therefore is not described in detail herein. For other implementations, the PSTN interface 230 may be omitted, or may be replaced with any other suitable interface that connects gateway 200 to a ground-based network (e.g., the Internet).

The LAN interface 240 may provide communication signals to, and receive communication signals from, an external LAN. For example, LAN interface 240 may be coupled to the internet 108 either directly or through additional infrastructure 106, as illustrated in FIG. 1. The LAN interface 240 is well known in the art, and therefore is not described in detail herein.

The gateway interface 245 may provide communication signals to, and receive communication signals from, one or more other gateways associated with the satellite communication system 100 of FIG. 1 (and/or to/from gateways associated with other satellite communication systems, not shown for simplicity). For some implementations, gateway interface 245 may communicate with other gateways via one or more dedicated communication lines or channels (not shown for simplicity). For other implementations, gateway interface 245 may communicate with other gateways using PSTN 110 and/or other networks such as the Internet 108 (see also FIG. 1). For at least one implementation, gateway interface 245 may communicate with other gateways via infrastructure 106.

Overall gateway control may be provided by gateway controller 250. The gateway controller 250 may plan and control utilization of satellite 300's resources by gateway 200. For example, the gateway controller 250 may analyze trends, generate traffic plans, allocate satellite resources, monitor (or track) satellite positions, and monitor the performance of gateway 200 and/or satellite 300. The gateway controller 250 may also be coupled to a ground-based satellite controller (not shown for simplicity) that maintains and monitors orbits of satellite 300, relays satellite usage information to gateway 200, tracks the positions of satellite 300, and/or adjusts various channel settings of satellite 300.

For the example implementation illustrated in FIG. 2, the gateway controller 250 includes a local time, frequency, and position references 251, which may provide local time and frequency information to the RF subsystem 210, the digital subsystem 220, and/or the interfaces 230, 240, and 245. The time and frequency information may be used to synchronize the various components of gateway 200 with each other and/or with satellite(s) 300. The local time, frequency, and position references 251 may also provide position information (e.g., ephemeris data) of satellite(s) 300 to the various components of gateway 200. Further, although depicted in FIG. 2 as included within gateway controller 250, for other implementations, the local time, frequency, and position references 251 may be a separate subsystem that is coupled to gateway controller 250 (and/or to one or more of digital subsystem 220 and RF subsystem 210).

Although not shown in FIG. 2 for simplicity, the gateway controller 250 may also be coupled to a network control center (NCC) and/or a satellite control center (SCC). For example, the gateway controller 250 may allow the SCC to communicate directly with satellite(s) 300, for example, to retrieve ephemeris data from satellite(s) 300. The gateway controller 250 may also receive processed information (e.g., from the SCC and/or the NCC) that allows gateway controller 250 to properly aim its antennas 205 (e.g., at the appropriate satellite(s) 300), to schedule beam transmissions, to coordinate handovers, and to perform various other well-known functions.

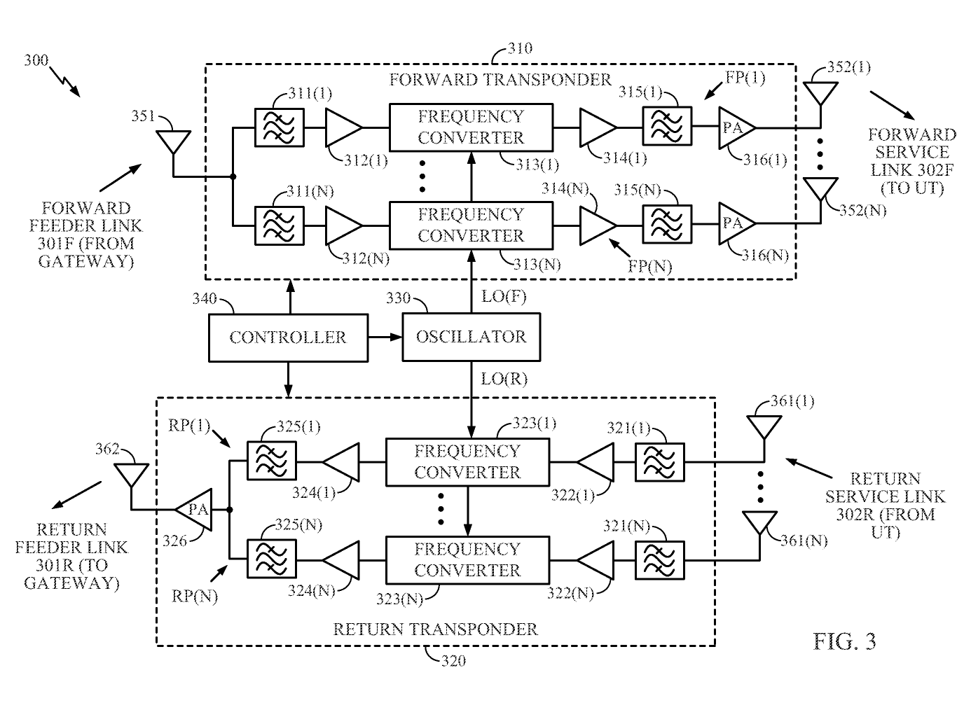

FIG. 3 is an example block diagram of satellite 300 for illustrative purposes only. It will be appreciated that specific satellite configurations may vary significantly and may or may not include on-board processing. Further, although illustrated as a single satellite, two or more satellites using inter-satellite communication may provide the functional connection between the gateway 200 and UT 400. It will be appreciated that disclosure is not limited to any specific satellite configuration and any satellite or combinations of satellites that may provide the functional connection between the gateway 200 and UT 400 may be considered within the scope of the disclosure. In one example, satellite 300 is shown to include a forward transponder 310, a return transponder 320, an oscillator 330, a controller 340, forward link antennas 351-352, and return link antennas 361-362. The forward transponder 310, which may process communication signals within a corresponding channel or frequency band, may include a respective one of first bandpass filters 311(1)-311(N), a respective one of first LNAs 312(1)-312(N), a respective one of frequency converters 313(1)-313(N), a respective one of second LNAs 314(1)-314(N), a respective one of second bandpass filters 315(1)-315(N), and a respective one of PAs 316(1)-316(N). Each of the PAs 316(1)-316(N) is coupled to a respective one of antennas 352(1)-352(N), as shown in FIG. 3.

Within each of the respective forward paths FP(1)-FP(N), the first bandpass filter 311 passes signal components having frequencies within the channel or frequency band of the respective forward path FP, and filters signal components having frequencies outside the channel or frequency band of the respective forward path FP. Thus, the pass band of the first bandpass filter 311 corresponds to the width of the channel associated with the respective forward path FP. The first LNA 312 amplifies the received communication signals to a level suitable for processing by the frequency converter 313. The frequency converter 313 converts the frequency of the communication signals in the respective forward path FP (e.g., to a frequency suitable for transmission from satellite 300 to UT 400). The second LNA 314 amplifies the frequency-converted communication signals, and the second bandpass filter 315 filters signal components having frequencies outside of the associated channel width. The PA 316 amplifies the filtered signals to a power level suitable for transmission to UTs 400 via respective antenna 352. The return transponder 320, which includes a number N of return paths RP(1)-RP(N), receives communication signals from UT 400 along return service link 302R via antennas 361(1)-361(N), and transmits communication signals to gateway 200 along return feeder link 301R via one or more antennas 362. Each of the return paths RP(1)-RP(N), which may process communication signals within a corresponding channel or frequency band, may be coupled to a respective one of antennas 361(1)-361(N), and may include a respective one of first bandpass filters 321(1)-321(N), a respective one of first LNAs 322(1)-322(N), a respective one of frequency converters 323(1)-323(N), a respective one of second LNAs 324(1)-324(N), and a respective one of second bandpass filters 325(1)-325(N).

Within each of the respective return paths RP(1)-RP(N), the first bandpass filter 321 passes signal components having frequencies within the channel or frequency band of the respective return path RP, and filters signal components having frequencies outside the channel or frequency band of the respective return path RP. Thus, the pass band of the first bandpass filter 321 may for some implementations correspond to the width of the channel associated with the respective return path RP. The first LNA 322 amplifies all the received communication signals to a level suitable for processing by the frequency converter 323. The frequency converter 323 converts the frequency of the communication signals in the respective return path RP (e.g., to a frequency suitable for transmission from satellite 300 to gateway 200). The second LNA 324 amplifies the frequency-converted communication signals, and the second bandpass filter 325 filters signal components having frequencies outside of the associated channel width. Signals from the return paths RP(1)-RP(N) are combined and provided to the one or more antennas 362 via a PA 326. The PA 326 amplifies the combined signals for transmission to the gateway 200.

Oscillator 330, which may be any suitable circuit or device that generates an oscillating signal, provides a forward local oscillator signal LO(F) to the frequency converters 313(1)-313(N) of forward transponder 310, and provides a return local oscillator signal LO(R) to frequency converters 323(1)-323(N) of return transponder 320. For example, the LO(F) signal may be used by frequency converters 313(1)-313(N) to convert communication signals from a frequency band associated with the transmission of signals from gateway 200 to satellite 300 to a frequency band associated with the transmission of signals from satellite 300 to UT 400. The LO(R) signal may be used by frequency converters 323(1)-323(N) to convert communication signals from a frequency band associated with the transmission of signals from UT 400 to satellite 300 to a frequency band associated with the transmission of signals from satellite 300 to gateway 200.

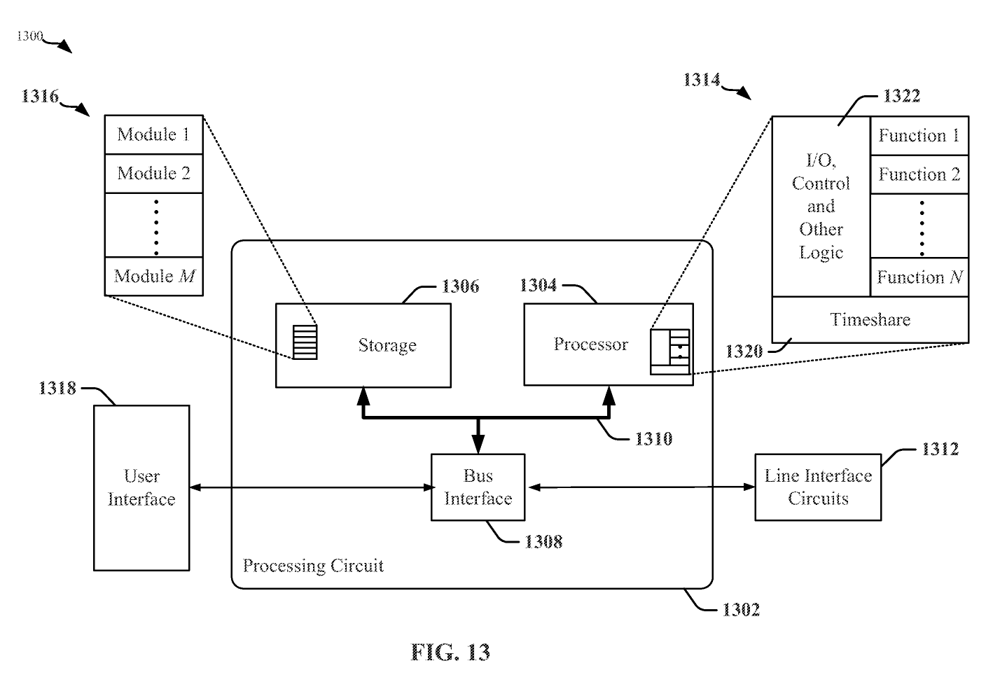

Controller 340, which is coupled to forward transponder 310, return transponder 320, and oscillator 330, may control various operations of satellite 300 including (but not limited to) channel allocations. In one aspect, the controller 340 may include a memory coupled to a processor (not shown for simplicity). In various examples, the processor may be implemented by the processing circuit 1302 illustrated in FIG. 13. The memory may include a non-transitory computer-readable medium (e.g., one or more nonvolatile memory elements, such as EPROM, EEPROM, Flash memory, a hard drive, etc.) storing instructions that, when executed by the processor, cause the satellite 300 to perform operations including (but not limited to) those described herein.

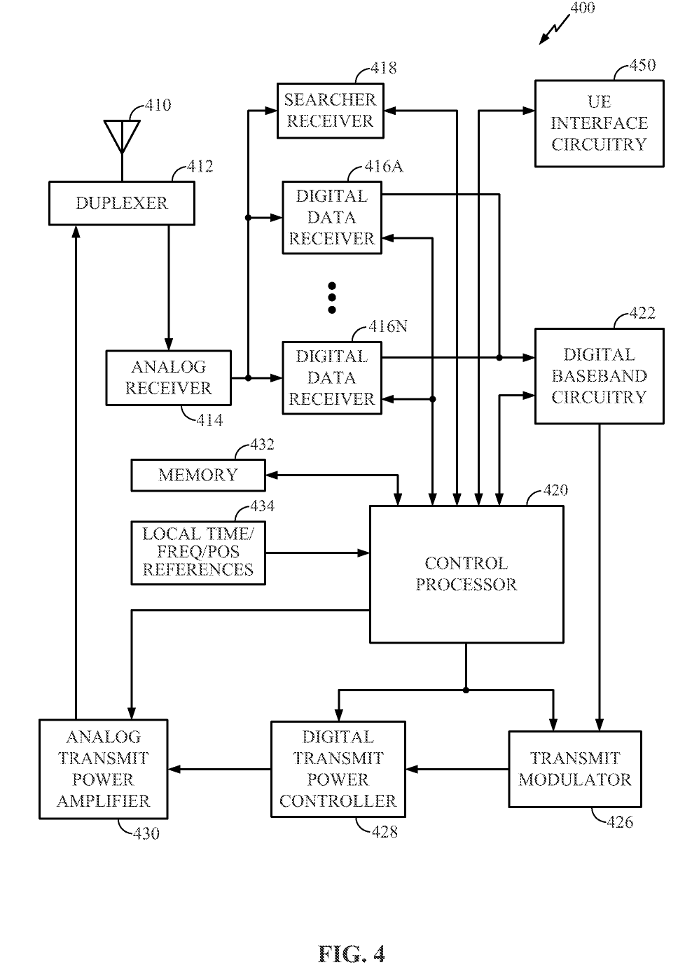

An example of a transceiver for use in the UT 400 or 401 is illustrated in FIG. 4. In FIG. 4, at least one antenna 410 is provided for receiving forward link communication signals (e.g., from satellite 300), which are transferred to an analog receiver 414, where they are down-converted, amplified, and digitized. In various aspects, the at least one antenna 410 is one of the antennas described in FIGS. 8 and 10-12. A duplexer 412 is often used to allow the same antenna to serve both transmit and receive functions. Alternatively, a UT transceiver may employ separate antennas for operating at different transmit and receive frequencies.

The digital communication signals output by the analog receiver 414 are transferred to at least one digital data receiver 416A and at least one searcher receiver 418. Additional digital data receivers to 416N may be used to obtain desired levels of signal diversity, depending on the acceptable level of transceiver complexity, as would be apparent to one skilled in the relevant art.

At least one user terminal control processor 420 is coupled to digital data receivers 416A-416N and searcher receiver 418. The control processor 420 provides, among other functions, basic signal processing, timing, power and handoff control or coordination (i.e., control/coordination), and selection of frequency used for signal carriers. That is, the control processor 420 may provide one or more of the following functions for the user terminal (UT): signal processing, timing control/coordination, power control/coordination, handoff control/coordination, or selection of a frequency for use for signal carriers.

Another basic control function that may be performed by the control processor 420 is the selection or manipulation of functions to be used for processing various signal waveforms. Signal processing by the control processor 420 may include a determination of relative signal strength and computation of various related signal parameters. Such computations of signal parameters, such as timing and frequency may include the use of additional or separate dedicated circuitry to provide increased efficiency or speed in measurements or improved allocation of control processing resources. In various examples, the control processor 420 may be implemented by the processing circuit 1302 illustrated in FIG. 13.

The outputs of digital data receivers 416A-416N are coupled to digital baseband circuitry 422 within the user terminal. The digital baseband circuitry 422 comprises processing and presentation elements used to transfer information to and from UE 500 as shown in FIG. 1, for example. Referring to FIG. 4, if diversity signal processing is employed, the digital baseband circuitry 422 may comprise a diversity combiner and decoder. Some of these elements may also operate under the control of, or in communication with, a control processor 420.

When voice or other data is prepared as an output message or communications signal originating with the user terminal, the digital baseband circuitry 422 is used to receive, store, process, and otherwise prepare the desired data for transmission. The digital baseband circuitry 422 provides this data to a transmit modulator 426 operating under the control of the control processor 420. The output of the transmit modulator 426 is transferred to a digital transmit power controller 428 which provides output power control to an analog transmit power amplifier 430 for final transmission of the output signal from the antenna 410 to a satellite (e.g., satellite 300).

In FIG. 4, the UT transceiver also includes a memory 432 associated with the control processor 420. The memory 432 may include a non-transitory computer-readable medium (e.g., one or more nonvolatile memory elements, such as EPROM, EEPROM, Flash memory, a hard drive, etc.) storing instructions that, when executed by the control processor 420, cause the user terminal 400 or 401 to perform operations including (but not limited to) those described herein. For example, the memory 432 may include instructions for configuring and monitoring the components of the UT transceiver. In addition, the memory 432 may include configuration data and monitoring data of the UT transceiver.

In the example illustrated in FIG. 4, the UT 400 also includes an optional local time, frequency and/or position references 434 (e.g., a GPS receiver), which may provide local time, frequency and/or position information to the control processor 420 for various applications, including, for example, time and frequency synchronization for the UT 400.

Digital data receivers 416A-N and searcher receiver 418 are configured with signal correlation elements to demodulate and track specific signals. Searcher receiver 418 is used to search for pilot signals, or other relatively fixed pattern strong signals, while digital data receivers 416A-N are used to demodulate other signals associated with detected pilot signals. However, a digital data receiver 416 may be assigned to track the pilot signal after acquisition to accurately determine the ratio of signal chip energies to signal noise, and to formulate pilot signal strength. Therefore, the outputs of these units may be monitored to determine the energy in, or frequency of, the pilot signal or other signals. These digital data receivers 416A-N also employ frequency tracking elements that may be monitored to provide current frequency and timing information to control processor 420 for signals being demodulated.

The control processor 420 may use such information to determine to what extent the received signals are offset from the oscillator frequency, when scaled to the same frequency band, as appropriate. This and other information related to frequency errors and frequency shifts may be stored in a storage element (e.g., memory 432) as desired.

The control processor 420 may also be coupled to UE interface circuitry 450 to allow communications between UT 400 and one or more UEs. UE interface circuitry 450 may be configured as desired for communication with various UE configurations and accordingly may include various transceivers and related components depending on the various communication technologies employed to communicate with the various UEs supported. For example, UE interface circuitry 450 may include one or more antennas, a wide area network (WAN) transceiver, a wireless local area network (WLAN) transceiver, a Local Area Network (LAN) interface, a Public Switched Telephone Network (PSTN) interface and/or other known communication technologies configured to communicate with one or more UEs in communication with UT 400.

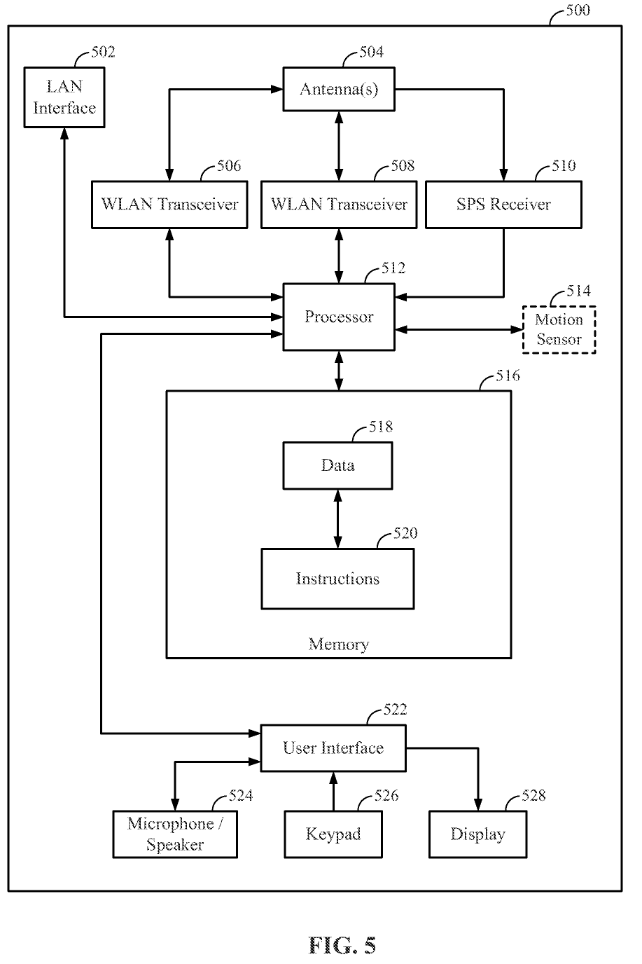

FIG. 5 is a block diagram illustrating an example of UE 500, which may also be applied to UE 501 of FIG. 1. The UE 500 as shown in FIG. 5 may be a mobile device, a handheld computer, a tablet, a wearable device, a smart watch, or any type of device capable of interacting with a user, for example. Additionally, the UE may be a network side device that provides connectivity to various ultimate end user devices and/or to various public or private networks. In the example shown in FIG. 5, the UE 500 may comprise a LAN interface 502, one or more antennas 504, a wide area network (WAN) transceiver 506, a wireless local area network (WLAN) transceiver 508, and a satellite positioning system (SPS) receiver 510.

The SPS receiver 510 may be compatible with the Global Positioning System (GPS), the Global Navigation Satellite System (GLONASS) and/or any other global or regional satellite based positioning system. In an alternate aspect, the UE 500 may include a WLAN transceiver 508, such as a Wi-Fi transceiver, with or without the LAN interface 502, WAN transceiver 506, and/or SPS receiver 510, for example. Further, UE 500 may include additional transceivers such as Bluetooth, ZigBee and other known technologies, with or without the LAN interface 502, WAN transceiver 506, WLAN transceiver 508 and/or SPS receiver 510. Accordingly, the elements illustrated for UE 500 are provided merely as an example configuration and are not intended to limit the configuration of UEs in accordance with the various aspects disclosed herein.

In the example shown in FIG. 5, a processor 512 is connected to the LAN interface 502, the WAN transceiver 506, the WLAN transceiver 508 and the SPS receiver 510. Optionally, a motion sensor 514 and other sensors may also be coupled to the processor 512. In various examples, the processor 512 may be implemented by the processing circuit 1302 illustrated in FIG. 13.

A memory 516 is connected to the processor 512. In one aspect, the memory 516 may include data 518 which may be transmitted to and/or received from the UT 400, as shown in FIG. 1. Referring to FIG. 5, the memory 516 may also include stored instructions 520 to be executed by the processor 512 to perform the process steps for communicating with the UT 400, for example. Furthermore, the UE 500 may also include a user interface 522, which may include hardware and software for interfacing inputs or outputs of the processor 512 with the user through light, sound or tactile inputs or outputs, for example. In the example shown in FIG. 5, the UE 500 includes a microphone/speaker 524, a keypad 526, and a display 528 connected to the user interface 522. Alternatively, the user's tactile input or output may be integrated with the display 528 by using a touch-screen display, for example. Once again, the elements illustrated in FIG. 5 are not intended to limit the configuration of the UEs disclosed herein and it will be appreciated that the elements included in the UE 500 will vary based on the end use of the device and the design choices of the system engineers.

Additionally, the UE 500 may be a user device such as a mobile device or external network side device in communication with but separate from the UT 400 as illustrated in FIG. 1, for example. Alternatively, the UE 500 and the UT 400 may be integral parts of a single physical device.

A user terminal may include an antenna for communicating with a satellite. Providing a high-gain receive beam in the antenna may include focusing radio energy from a large aperture into a low-gain feed. In one or more aspects, an antenna with a high-gain receive beam may be a directional antenna with a focused, narrow radio wave beam width. In one or more aspects, a low-gain antenna may be an omnidirectional antenna with a broad radio wave beam width. For example, an antenna may transmit or receive signals better in one direction vs. another. An antenna with a narrow beam may transmit or receive signals over a narrow set of directions (or angles) with respect to the direction it is pointed compared with an antenna with a broader beam.

Conversely, providing a high-gain transmit beam in the antenna may include collimating radio energy from a low-gain feed to a large aperture for transmission. The relative positions of the aperture and the feed are arranged to form a collimated beam in the direction of the satellite with which the user terminal (and hence, the antenna) is attempting to communicate. Since the satellite moves relative to the user terminal, the position of the feed relative to the aperture may be moved to maintain the high-gain beam pointing at the satellite. That is, the position of the feed relative to the aperture is used to steer the high-gain beam.

Various types of apertures may be used with the antenna, for example, a classical Luneburg lens. A classical Luneburg lens is a spherically-shaped lens with a spherically-symmetric refractive index. For example, a spherically-symmetric refractive index may follow a refractive index profile n(r):

n(r)=sqrt(2−r²), where r is a normalized radius, ranging from r=0 to r=1.
That is, the refractive index starts at a value of √2 (i.e., sqrt (2)) at the sphere center and continuously decreases to a value of 1 at the sphere outer radius. The spherically-symmetric refractive index may be formed using appropriate dielectric material suitable for the operational frequency range of interest. The classical Luneburg lens includes the features of broadband operation, passive wide angle scanning, wide angle focusing, and multi-beam operation

In addition to the classical Luneburg lens, a stepped Luneburg lens may also be used with the antenna. A stepped Luneburg lens may be formed by stepped radial layers to emulate the classical Luneburg lens using discrete approximations to the spherically-symmetric refractive index. Other types of Luneburg lens may also be applicable to the antenna, such as a semi-spherical Luneburg lens or a cylindrical Luneburg lens. In addition to the various types of Luneburg lens, various other types of apertures may be used in the present disclosure, for example, a spherical reflector, a parabolic reflector, vanes of conductive material, a dielectric lens, a metal plate antenna, a Rotman lens, etc. One skilled in the art would understand that various other apertures not listed herein may be used within the scope and spirit of the present disclosure.

In various examples, the antenna includes a classical Luneburg lens (hereon referred to as a Luneburg lens) and a helical feed. In various examples, the helical feed is used for performance in Ku-band (12-18 GHz), L-band (1-2 GHz) or in S-band (2-4 GHz). Although listed herein as examples are Ku-band, L-band and S-band, other frequency bands may be also be used within the scope and spirit of the present disclosure. In addition to the helical feed, various other types of feeds may be used in the present disclosure, for example, a horn, an open waveguide, a dipole, a backfire feed, etc. One skilled in the art would understand that various other feeds not listed herein may be used within the scope and spirit of the present disclosure.

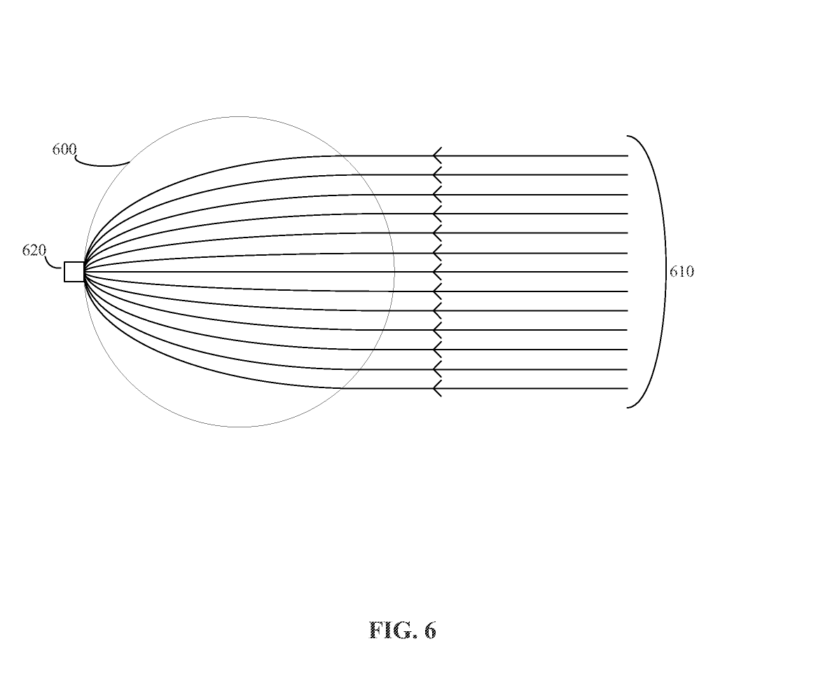

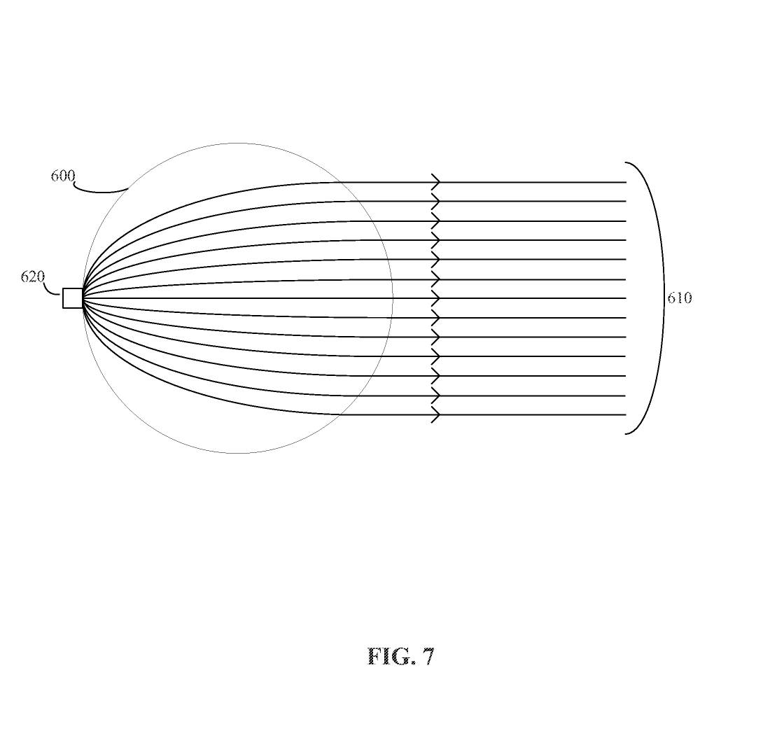

The Luneburg lens is a sphere made of dielectric material with a radially gradient refractive index. FIGS. 6 and 7 are two diagrams illustrating the focusing property of a Luneburg lens 600. The Luneburg lens 600 includes the property of focusing multiple beams. For example, a feed placed anywhere on the surface of the Luneburg lens produces a fully collimated beam in the opposite direction. For example, the Luneburg lens 600 includes the property of focusing a plane wave 610 incident on one side to a focal point 620 opposite the incidence. With the use of a Luneburg lens, the helical feed may be positioned anywhere on the surface of the lens to produce a fully collimated beam in any direction, thus improving the efficient use of the aperture. The focal point 620, shown in FIGS. 6 and 7, would represent the position of the helical feed. The arrows of the plane wave 610, as shown in FIG. 6, indicate that the plane waves 620 are being directed towards the focal point 620 (i.e., being received by the helical feed). FIG. 7 shows the reverse direction (i.e., the helical feed transmitting).

FIG. 8 is a diagram illustrating an example antenna 800 with a single feed, as it may be implemented according to some aspects of the present disclosure. The antenna includes a vertical shaft 801 for mounting various components that make up the antenna. Bearings 803 (not directly shown) are part of the vertical shaft 801 and they provide smooth rotation about a vertical axis 802 associated with the vertical shaft 801. Various components of the antenna 800 are supported by and rotate around the vertical shaft 801. The rotation around the vertical shaft 801 moves the beam produced by the feed 822 (e.g., a helical feed 822) in the azimuth direction. An azimuth drive motor 805 is coupled to the vertical shaft 801 and rotates the vertical shaft 801 and the rest of the antenna. The azimuth drive motor 805 may be a stepper motor, a servo motor or any other type of motor where the speed and position of the motor shaft 806 may be controlled. The coupling mechanism 807 between the azimuth drive motor 805 and the vertical shaft 801 may be a toothed belt, a V-belt, a chain, a cable, or any other type of drive coupling including a direct drive from the motor shaft 806.

Position feedback associated with the azimuth drive motor 805 may be provided by an optical or a mechanically switched index at a reference point in the rotation. The reference point may be an arbitrary point that may be predetermined or picked by a designer. This is a rotational position around the vertical axis 802 relative to the reference point. Position of the antenna 800 around the vertical axis 802 away from the index may be provided by counting steps of a stepper motor or by a relative encoder or an absolute encoder. A relative or absolute encoder (not shown) may be mounted on the vertical shaft 801 or the motor shaft 806. Other ways of obtaining position feedback may also be used and still be within the scope and spirit of the present disclosure.

The antenna 800 includes a track 810 and a feed trolley 820. In various examples, the track 810 may be a semi-circle in shape, a portion of a circle in shape, a semi-ellipse in shape, a portion of an ellipse in shape, or some other shape variations. For less than full sky coverage, the track 810 may be reduced in length and the lens 850 (e.g., Luneburg lens) may be structurally supported at low points on the surface of the lens, leaving more of the surface unblocked. One skilled in the art would understand that the shape of the track 810 may depend on factors such as, but not limited to, the type of aperture in use, the type of satellite (e.g., LEO satellite versus geosynchronous (GEO) satellite, etc.) the antenna is attempting to communicate with, etc. The feed trolley 820 moves along the track 810 such that the feed 822 (e.g., helical feed) is always pointed at the center 851 of the lens 850. The feed trolley 820 may ride on wheels 824 that run on the track 810. In various examples, the feed trolley 820 may ride on bearings (not shown) in lieu of wheels 824. However, one skilled in the art would understand that other substitutions for the wheels 824 may be used to move the feed trolley 820 along the track 810.

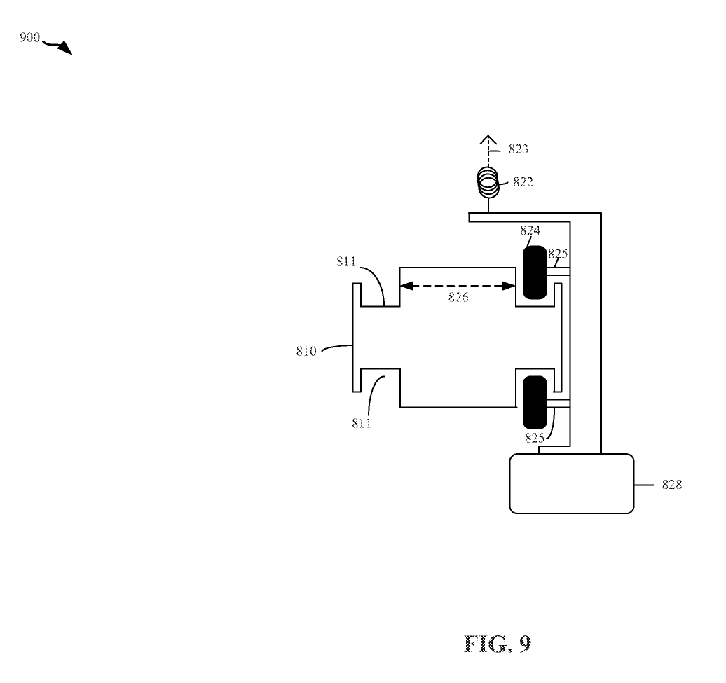

FIG. 9 is a diagram illustrating an example of a track 810 with a feed trolley 820 in a cross sectional view. FIG. 9 shows that the track 810 includes 4 wheel-tracks (i.e., two pairs of wheel-tracks 811) to accommodate the wheels 824 of the feed trolley 820 to move along the track 810. In the cross sectional view shown in FIG. 9, the track 810 is symmetric along its vertical direction to accommodate two feed trolleys, one on each side of the track 810 through each of the two pairs of wheel-tracks 811. The thickness of the track shown by 826 may vary to accommodate two feed trolleys, one opposite the other, so that each feed trolley may move freely along the entire length of the track without hitting the other feed trolley. However, in other examples that accommodate a single feed trolley 820, the track may include one pair of wheel-tracks without necessitating tracks for a second feed trolley.

The feed trolley 820 is configured to couple to the feed 822 (e.g., helical feed 822), which is mounted on the feed trolley 820 to align the feed 822 with the center of the lens 850. For example, the feed trolley 820 may house the feed 822. As shown in FIG. 9, the feed trolley 820 moves along one side of the track 810. In various examples, radio electronics (not shown) may be mounted on the side or bottom of the feed trolley 820. A cable or another connecting mechanism (not shown) may connect the feed trolley 820 to another module or structure to convey radio and control signals to and/or from the feed trolley 820 as needed. In various examples. The module or structure for conveying radio and control signals may be housed in the lower portion 828 of the feed trolley 820.

Referring once again to FIG. 8, the feed trolley 820 is moved along the track 810 by an elevation drive motor 830. The elevation drive motor 830 controls the rotation of the feed trolley 820 around an elevation axis 852. The elevation axis is centered at the center 851 of the lens 850. The elevation axis 852 points out of the plane of the drawing of FIG. 8. In various examples, the antenna 800 includes a frame 840 that includes a horizontal member 842 and two arms 845, 846. As shown in FIG. 8, the elevation drive motor 830 is mounted at the bottom of one of the arms (i.e., arm 846). The frame includes a flexible member 849. The flexible member 849 may be a toothed belt, a V-belt, a chain, a cable or any other type of drive coupling, including a direct drive of the trolley wheels 824 by the elevation drive motor shaft 831. The elevation drive motor 830 may be a stepper motor, a servo motor or any other type of motor where the speed and position of the elevation drive motor shaft 831 may be controlled.

Position feedback associated with the elevation drive motor 830 may be an optical or a mechanically switched index at a reference point in the rotation. Position of a feed axis 823 away from the index may be provided by counting steps of a stepper motor or by a relative encoder or an absolute encoder. A relative or absolute encoder (not shown) may be mounted linearly along the track 810 or may be mounted on the elevation drive motor shaft 831 or on a trolley wheel shaft 825 (shown in FIG. 9). Other ways of obtaining position feedback may also be used and still be within the scope and spirit of the present disclosure.

The elevation drive motor 830 moves the flexible member 849 and pulls the feed trolley 820 along the track 810. Pulleys 847 on each arm 845, 846 guide the flexible member 849 in moving the feed trolley 820 along the track 810. In various examples, the flexible member 849 may be a toothed belt reinforced with Kevlar fiber for increased pulling strength while still maintaining its light-weight feature.

The elevation drive motor 830 (e.g., implemented using a stepper motor) and the flexible member 849 (e.g., implemented by a toothed belt) are used to provide rapid and precisely controlled movement of the feed trolley 820, and hence, the feed 822 mounted on the feed trolley 820. In various examples, the type of elevation drive motor 830 may be selected with the capability of providing holding torque when power is removed or operated at reduced current. Likewise, the type of elevation drive motor 830 may be selected such that when moving the feed 822 slowly for satellite tracking, the current requirement of the elevation drive motor 830 may be reduced. In various examples, for reasons of reducing power consumption and reducing excess heating, the elevation drive motor 830 may only have full power applied to it when it is moving the feed trolley 820 rapidly.

In various examples, less than 2 seconds are required to move the feed trolley (and hence, the feed 822) from one position to a second widely spaced (i.e., non-coincident) position during, for example, a satellite handoff procedure. In various examples, the flexible member 849 moves the feed trolley 820 (and hence, the feed 822) along the track to a first destination or to a second destination. When moving the feed trolley 820 (and hence the feed 822) along the track 810 to the first destination, the feed 822 (through the lens 850) forms a first collimated beam pointing to a first satellite, and when moving the feed trolley 820 (and hence the feed 822) along the track 810 to the second destination, the feed 822 (through the lens 850) forms a second collimated beam pointing to a second satellite. The elevation drive motor 830 controls the flexible member 849 to either move the feed trolley 820 (and hence the feed 822) to the first destination or to the second destination. In various examples, the first satellite is a setting satellite and the second satellite is a rising satellite, such that changing from moving the feed trolley 820 (and hence the feed 822) along the track to the first destination to moving the feed trolley 820 (and hence the feed 822) along the track to the second destination facilitates a satellite handoff procedure.

The antenna 800 includes a lens 850. In various examples, the lens 850 is a classical Luneburg lens ((hereon referred to as a Luneburg lens). As illustrated in FIG. 8, the Luneburg lens 850 allows the placement of the feed 822 (and any feed support structure such as the feed trolley 820) in a position so as not to block the aperture (i.e., the Luneburg lens 850). This relative positioning of the Luneburg lens 850 and the feed 822 may improve the aperture efficiency for focusing the resulting beam. Additionally, with the relative positioning of the Luneburg lens 850 and the feed 822, the resulting beam points “up” toward the satellite for communication while the feed 822 (and its associated feed support structure) are located “down”, away from the direction the beam is pointing.

In various examples for satellite communications, the resulting beam points to any elevation direction from zenith to 45 degrees from zenith. This requires that the feed be positioned at the nadir or any position within 45 degrees of nadir. With the example of the Luneburg lens 850, which is spherical in shape, and the feed 822 moving along the track 810 that places the feed 822 along the bottom surface of the spherically shaped Luneburg lens 850, the resulting beam is a collimated beam 855 pointing straight up from the feed 822 through the Luneburg lens 850. Although the collimated beam 855 is formed at a distance away from the aperture (i.e., at a far-field distance 2D²/λ, where D is the aperture diameter and λ is the wavelength), for the ease of illustration, the collimated beam 855 is shown as emanating from the feed 822 in FIG. 8. And, moving the feed 822 along the track 810, that is, along the surface of the Luneburg lens 850, moves the direction of where the collimated beam 855 points.

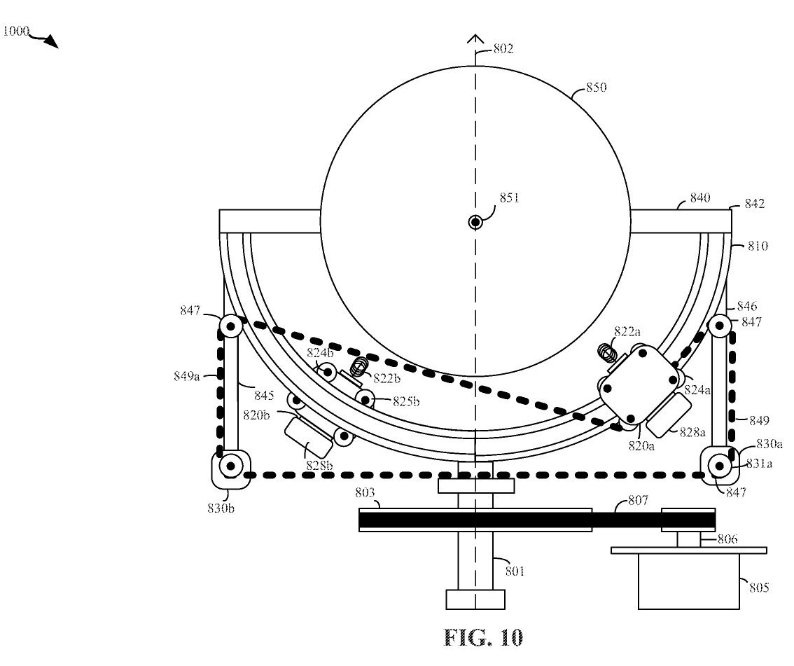

To reduce the time for switching from one satellite to another satellite, a second feed may be used. FIG. 10 is a diagram illustrating an example antenna 1000 with two feeds 822a, 822b. For the sake of brevity, the descriptions of the components illustrated in FIG. 10 that are the same as those illustrated in FIG. 8 are not repeated herein. The item numbers that identify the components illustrated in FIG. 8 are repeated in the same components that are illustrated in FIG. 10. In the antenna 1000 illustrated in FIG. 10, there are two feed trolleys 820a, 820b, each with its respective wheels 824a, 824b; two feeds 822a, 822b; two elevation drive motors 830a, 830b; and two flexible members 849a, 849b (flexible member 849b not shown).

Two feeds 822a, 822b are supported by their respective feed trolleys 820a, 820b that run on opposite sides of the track 810. Since the feeds 822a, 822b are both on the track 810, the feeds 822a, 822b cannot pass each other, but they can mechanically approach as close to each other such that the two feeds 822a, 822b are near touching. A second elevation drive motor 830b, shown on the left side in FIG. 10, moves the second feed trolley 820b independently of the first feed trolley 820a. The flexible member 849b which pulls the second feed trolley 820b is not shown for clarity.

In operation, satellites are usually not close to each other at the point of switching between a first satellite and a second satellite. As the first feed is moved to track the first satellite toward the horizon, the second feed would be pre-positioned at an appropriate elevation direction to track the second satellite. For example, the second feed would be positioned nearly 180 degrees in the azimuth direction away from the first feed's pointing direction and close to the azimuth direction needed to access the second satellite. With this relative pointing geometry between the first feed and the second feed, switching from the first satellite to the second satellite would involve a small change in the azimuth direction and thus, may improve the satellite switching time (i.e., reduce the switching time from the first satellite to the second satellite) from just using a single feed antenna.

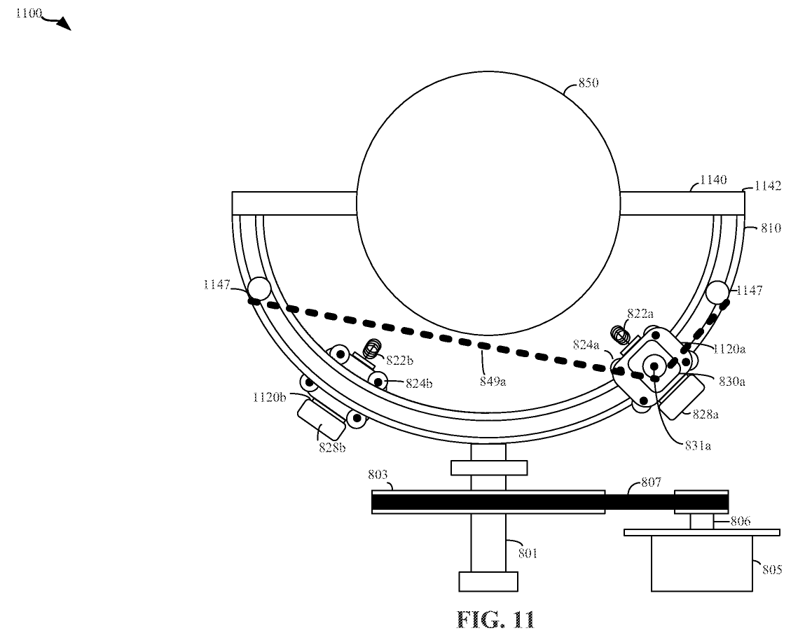

FIG. 11 is a diagram illustrating an example antenna 1100 with two feeds 822a, 822b and two moving feed trolleys 1120a, 1120b. For the sake of brevity, the descriptions of the components illustrated in FIG. 11 that are the same as those illustrated in FIG. 10 are not repeated herein. The item numbers that identify the components illustrated in FIG. 10 are repeated in the same components that are illustrated in FIG. 11. In FIG. 11, the frame 1140 includes a horizontal member 1142. But, unlike the frame 840 in FIGS. 8 and 10, the frame 1140 does not include arms, which in the examples in FIGS. 8 and 10 housed the elevation drive motors. In the example antenna 1100, the elevation drive motors 830a, 830b are mounted on their respective moving feed trolleys 1120a, 1120b. In the example depicted in FIG. 11, the elevation drive motors 830b, 830b, each pull along the track 810.

The elevation drive motors 830a, 830b each move their own weight along with the moving feed trolleys 1120a, 1120b. Pulleys 1147 are housed on the track 810. The flexible members 849a, 849b (flexible member 849b not shown) are connected to the pulleys 1147 and wrap around their respective elevation drive motors 830a, 830b. In various examples, the configuration of how the flexible members 849a, 849b are each connected to the pulleys 1147 and wrapped around their respective elevation drive motors 830a, 830b reduces the contact area of the flexible members and may require that the flexible members 849a, 849b be taut.

In various examples, the flexible members 849a, 849b are toothed belts. For example, each of the toothed belts is coupled to a groove of the track 810. One of the wheels 824a, 824b of the respective feed trolleys 1120a, 1120b may be a toothed pulley that engages the toothed side of the toothed belt. Spring tension may hold the toothed pulley against the toothed belt for accurate engagement.

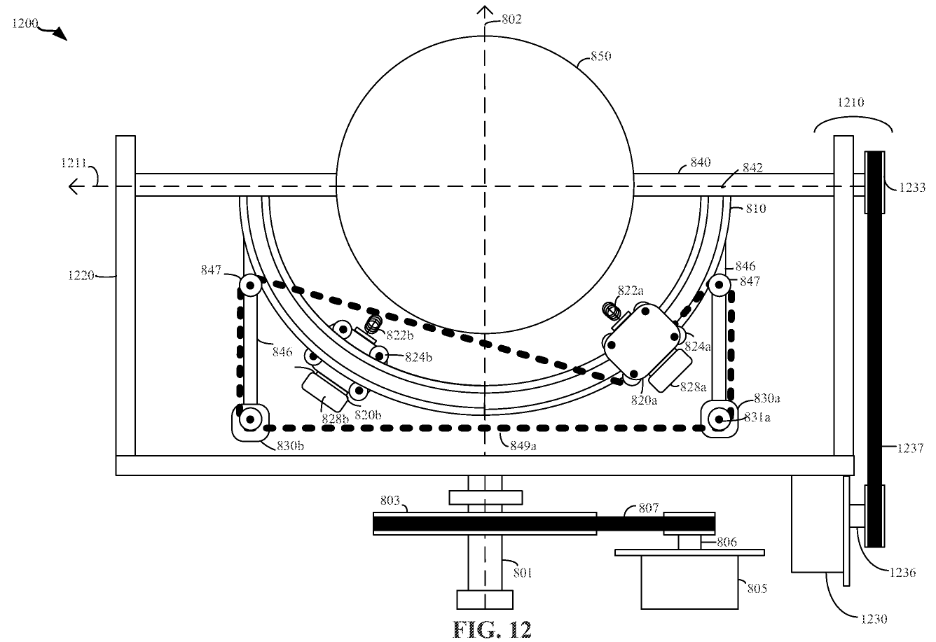

FIG. 12 is a diagram illustrating an example antenna 1200 with a two feeds 822a, 822b and possessing three degrees of freedom. For the sake of brevity, the descriptions of the components illustrated in FIG. 12 that are the same as those illustrated in FIG. 10 are not repeated herein. The item numbers that identify the components illustrated in FIG. 10 are repeated in the same components that are illustrated in FIG. 12. The example antenna 1200 includes a tilt mechanism 1210. The tilt mechanism 1210 provides a third degree of freedom around a tilt axis 1211. In another way of stating this, the tilt mechanism tilts the track 810 and the feed trolleys 820a, 820b (along with their respective feeds 822a, 822b) in a third dimension with respect to the lens 850.

The tilt mechanism 1210 adds to the rotation (via the azimuth drive motor 805) and the elevation direction movement (via the track 810 and the elevation drive motors 820a, 820b) to prove a third degree of freedom in addition to the azimuth direction and elevation direction pointing. This third degree of freedom allows each of the beams (associated with the respective feeds 822a, 822b) to be pointed in unconstrained directions in the upper hemisphere above the ground level (i.e., 2π steradians around the vertical axis 802). The third degree of freedom may eliminate or reduce outages in connection to a satellite while the feeds 822a, 822b are repositioning to communicate with a different satellite. The third degree of freedom may allow simultaneous pointing of the beams from the feeds 822a, 822b at two satellites in positions in the upper hemisphere above the ground level.

The tilt mechanism 1210 includes a yoke, for example, a U-shaped yoke 1220. In various examples, the U-shaped yoke 1220 is connected to the frame 840, for example, to the horizontal member 842 as illustrated in FIG. 12. The tilt mechanism 1210 also includes a tilt drive motor 1230 and a tilt coupling mechanism 1237. The tilt drive motor 1230 and the tilt coupling mechanism are connected by a tilt motor shaft 1236. Tilt bearings 1233 (not directly shown) are part of the tilt mechanism 1210 to provide smooth tilting of the U-shaped yoke 1220. The tilt drive motor 1230 provides the tilt drive. In various examples, the tilt drive motor 1230 may be mounted on the U-shaped yoke 1220, for example, with a toothed belt (as the tilt coupling mechanism 1237). In various examples, the tilt drive motor 1230 may drive the tilt motor shaft 1236 directly or through a bell-crank.

The track 810 along with the feed trolleys 820a, 820b and the respective feeds 822a, 822b may be suspended by U-shaped yoke 1220 such that the track 810 along with the feed trolleys 820a, 820b and the respective feeds 822a, 822b are free to tilt in and out in a third direction orthogonal to the azimuth direction (e.g., first direction) and the elevation direction (e.g., second direction). Although the U-shaped yoke 1220 is depicted as a U-shape, one skilled in the art would understand that other types of shapes may be used for providing the functionality of the U-shaped yoke 1220.

In various examples, with the track 810 oriented in a plane defined by two satellites and the antenna 1200, the feeds may point at the two satellites simultaneously. Both the vertical axis 802 and the tilt axis 1211 may be used for this orientation. The position of the feed trolleys 820a, 820b define the beam pointing from their respective feeds 822a, 822b at the two satellites within the plane.

By enabling the antenna 1200 to point at two satellites simultaneously, a user terminal may establish the connection to the rising satellite before relinquishing the connection to the setting satellite. In various examples, when the radio links to the satellites are degraded due to distance and/or beam-edge roll-off, data may be communicated over both satellites to increase throughput. In various examples, if a setting satellite is obstructed by a building or a natural feature, having the communications link already established with the rising satellite ensures that control channels are available to complete the handoff from the setting satellite to the rising satellite. In various examples, the setting satellite is the first satellite and the rising satellite is the second satellite (as in the previous examples). The tilt mechanism 1210 may also be added to the example antenna 1100 in FIG. 11 to provide a third degree of freedom.

In various aspects, the antenna disclosed in FIGS. 8-12 may include a lens; a first feed trolley configured to couple to a first feed, wherein the first feed is configured to form a first collimated beam through the lens in a first direction; a second feed trolley configured to couple to a second feed, wherein the second feed is configured to form a second collimated beam through the lens in a second direction; a track coupled to the first feed trolley and the second feed trolley, wherein the first feed coupled to the first feed trolley is configured to move along the track to a first destination to form the first collimated beam through the lens in the first direction and the second feed coupled to the second feed trolley is configured to move along the track to a second destination to form the second collimated beam through the lens in the second direction; and a first flexible member connected to the first feed trolley configured to move the first feed coupled to the first feed trolley along the track, and a second flexible member connected to the second feed trolley configured to move the second feed coupled to the second feed trolley along the track.

In various aspects, the antenna disclosed in FIGS. 8-12 may include a lens; a feed trolley configured to couple to a feed; a track coupled to the feed trolley; a flexible member connected to the feed trolley configured to move the feed coupled to the feed trolley along the track to a first destination or to a second destination, wherein the feed is configured to move along the track to the first destination to form a first collimated beam through the lens to point to a first satellite, and wherein the feed is configured to move along the track to the second destination to form a second collimated beam through the lens to point to a second satellite. In various examples, the antenna includes a second feed trolley and a second feed, and the track includes two sides to accommodate a feed trolley on each side.

One skilled in the art would understand that the figures (FIGS. 8, 10, 11, 12) are drawn with some emphasis placed on the mechanical parts of the antenna. Thus, the relative sizes of the lens and the other components and/or structures may be different in different implementations. For example, the aperture (i.e., the lens) may be much larger relative to the other components and/or structures.

FIG. 13 is a conceptual diagram 1300 illustrating a simplified example of a hardware implementation for an apparatus employing a processing circuit 1302 that may be configured to perform one or more functions disclosed herein. In accordance with various aspects of the disclosure, an element, or any portion of an element, or any combination of elements as disclosed herein may be implemented utilizing the processing circuit 1302. In various examples, the processing circuit 1302 may be used as one or more of the following: a processor within the controller 340 illustrated in FIG. 3, the control processor 420 illustrated in FIG. 4 and/or the processor 512 illustrated in FIG. 5. The processing circuit 1302 may include one or more processors 1304 that are controlled by some combination of hardware and software modules. Examples of processors 1304 include microprocessors, microcontrollers, digital signal processors (DSPs), field programmable gate arrays (FPGAs), programmable logic devices (PLDs), state machines, sequencers, gated logic, discrete hardware circuits, and other suitable hardware configured to perform the various functionality described throughout this disclosure. The one or more processors 1304 may include specialized processors that perform specific functions, and that may be configured, augmented or controlled by one of the software modules 1316. The one or more processors 1304 may be configured through a combination of software modules 1316 loaded during initialization, and further configured by loading or unloading one or more software modules 1316 during operation.

In the illustrated example, the processing circuit 1302 may be implemented with a bus architecture, represented generally by the bus 1310. The bus 1310 may include any number of interconnecting buses and bridges depending on the specific application of the processing circuit 1302 and the overall design constraints. The bus 1310 links together various circuits including the one or more processors 1304, and storage 1306. Storage 1306 may include memory devices and mass storage devices, and may be referred to herein as computer-readable storage media and/or processor-readable storage media. The bus 1310 may also link various other circuits such as timing sources, timers, peripherals, voltage regulators, and power management circuits. A bus interface 1308 may provide an interface between the bus 1310 and one or more transceivers 1312 (a.k.a., line interface circuits). A transceiver 1312 may be provided for each networking technology supported by the processing circuit. In some instances, multiple networking technologies may share some or all of the circuitry or processing modules found in a transceiver 1312. Each transceiver 1312 provides a means for communicating with various other apparatus over a transmission medium. Depending upon the nature of the apparatus, a user interface 1318 (e.g., keypad, display, speaker, microphone, joystick) may also be provided, and may be communicatively coupled to the bus 1310 directly or through the bus interface 1308.

A processor 1304 may be responsible for managing the bus 1310 and for general processing that may include the execution of software stored in a computer-readable storage medium that may include the storage 1306. In this respect, the processing circuit 1302, including the processor 1304, may be used to implement any of the methods, functions and techniques disclosed herein. The storage 1306 may be used for storing data that is manipulated by the processor 1304 when executing software, and the software may be configured to implement any one of the methods disclosed herein.

One or more processors 1304 in the processing circuit 1302 may execute software. Software shall be construed broadly to mean instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in computer-readable form in the storage 1306 or in an external computer-readable storage medium. The external computer-readable storage medium and/or storage 1306 may include a non-transitory computer-readable storage medium. A non-transitory computer-readable storage medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a “flash drive,” a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable storage medium and/or storage 1306 may also include, by way of example, a carrier wave, a transmission line, and any other suitable medium for transmitting software and/or instructions that may be accessed and read by a computer. Computer-readable storage medium and/or the storage 1306 may reside in the processing circuit 1302, in the processor 1304, external to the processing circuit 1302, or be distributed across multiple entities including the processing circuit 1302. The computer-readable storage medium and/or storage 1306 may be embodied in a computer program product. By way of example, a computer program product may include a computer-readable storage medium in packaging materials. Those skilled in the art will recognize how best to implement the described functionality presented throughout this disclosure depending on the particular application and the overall design constraints imposed on the overall system.

The storage 1306 may maintain software maintained and/or organized in loadable code segments, modules, applications, programs, etc., which may be referred to herein as software modules 1316. Each of the software modules 1316 may include instructions and data that, when installed or loaded on the processing circuit 1302 and executed by the one or more processors 1304, contribute to a run-time image 1314 that controls the operation of the one or more processors 1304. When executed, certain instructions may cause the processing circuit 1302 to perform functions in accordance with certain methods, algorithms and processes described herein.

Some of the software modules 1316 may be loaded during initialization of the processing circuit 1302, and these software modules 1316 may configure the processing circuit 1302 to enable performance of the various functions disclosed herein. For example, some software modules 1316 may configure internal devices and/or logic circuits 1322 of the processor 1304, and may manage access to external devices such as the transceiver 1312, the bus interface 1308, the user interface 1318, timers, mathematical coprocessors, and so on. The software modules 1316 may include a control program and/or an operating system that interacts with interrupt handlers and device drivers, and that controls access to various resources provided by the processing circuit 1302. The resources may include memory, processing time, access to the transceiver 1312, the user interface 1318, and so on.

One or more processors 1304 of the processing circuit 1302 may be multifunctional, whereby some of the software modules 1316 are loaded and configured to perform different functions or different instances of the same function. The one or more processors 1304 may additionally be adapted to manage background tasks initiated in response to inputs from the user interface 1318, the transceiver 1312, and device drivers, for example. To support the performance of multiple functions, the one or more processors 1304 may be configured to provide a multitasking environment, whereby each of a plurality of functions is implemented as a set of tasks serviced by the one or more processors 1304 as needed or desired. In various examples, the multitasking environment may be implemented utilizing a timesharing program 1320 that passes control of a processor 1304 between different tasks, whereby each task returns control of the one or more processors 1304 to the timesharing program 1320 upon completion of any outstanding operations and/or in response to an input such as an interrupt. When a task has control of the one or more processors 1304, the processing circuit is effectively specialized for the purposes addressed by the function associated with the controlling task. The timesharing program 1320 may include an operating system, a main loop that transfers control on a round-robin basis, a function that allocates control of the one or more processors 1304 in accordance with a prioritization of the functions, and/or an interrupt driven main loop that responds to external events by providing control of the one or more processors 1304 to a handling function.

Additionally, the components described in FIGS. 4-5 and 13 may be implemented to perform some or all the features of the diagrams of FIGS. 8-12. Several aspects of the example antennas have been presented. As those skilled in the art will readily appreciate, various aspects described throughout this disclosure may be extended to various other types of antennas.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The methods, sequences or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor may read information from, and write information to, the storage medium. In the alternative, the storage medium may be integral to the processor.

Accordingly, one aspect of the disclosure may include a non-transitory computer readable medium embodying a method for satellite user terminal antenna pointing with different degrees of freedom. The term “non-transitory” does not exclude any physical storage medium or memory and particularly does not exclude dynamic memory (e.g., conventional random access memory (RAM)) but rather excludes only the interpretation that the medium can be construed as a transitory propagating signal.

While the foregoing disclosure shows illustrative aspects, it should be noted that various changes and modifications could be made herein without departing from the scope of the appended claims. The functions, steps or actions of the method claims in accordance with aspects described herein need not be performed in any particular order unless expressly stated otherwise. Furthermore, although elements may be described or claimed in the singular, the plural is contemplated unless limitation to the singular is explicitly stated. Accordingly, the disclosure is not limited to the illustrated examples and any means for performing the functionality described herein are included in aspects of the disclosure.

What is claimed is:

1. An antenna comprising:
a lens;
a first feed trolley configured to couple to a first feed, wherein the first feed is configured to form a first collimated beam through the lens in a first direction;
a second feed trolley configured to couple to a second feed, wherein the second feed is configured to form a second collimated beam through the lens in a second direction;
a track coupled to the first feed trolley and the second feed trolley, wherein the first feed coupled to the first feed trolley is configured to move along the track to a first destination to form the first collimated beam through the lens in the first direction and the second feed coupled to the second feed trolley is configured to move along the track to a second destination to form the second collimated beam through the lens in the second direction; and
a first flexible member connected to the first feed trolley configured to move the first feed coupled to the first feed trolley along the track, and a second flexible member connected to the second feed trolley configured to move the second feed coupled to the second feed trolley along the track.

2. The antenna of claim 1, further comprising a first elevation drive motor configured to control the first flexible member configured to move the first feed coupled to the first feed trolley along the track with respect to an elevation axis, and a second elevation drive motor configured to control the second flexible member configured to move the second feed coupled to the second feed trolley along the track with respect to the elevation axis, wherein the first elevation drive motor is housed external to the first feed trolley and the track, and the second elevation drive motor is housed external to the second feed trolley and the track.

3. The antenna of claim 2, further comprising a first side on the track configured to move the first feed along the track and a second side on the track configured to move the second feed along the track, wherein the first side and the second side are on opposite sides of the track.

4. The antenna of claim 3, wherein the first feed along the first side and the second feed along the second side are positioned opposite to each other on the track such that the first direction and the second direction are the same.

5. The antenna of claim 1, further comprising an azimuth drive motor connected to the track, wherein the track is configured to rotate around a vertical axis to provide a second degree of freedom with respect to an elevation axis.

6. The antenna of claim 5, further comprising a yoke connected to the track, wherein the track is configured to rotate around a tilt axis to provide a third degree of freedom with respect to the vertical axis and the elevation axis.

7. The antenna of claim 1 wherein the first direction points to a first satellite and the second direction points to a second satellite.

8. The antenna of claim 1, wherein the lens is a Luneburg lens.

9. The antenna of claim 1, wherein the first flexible member or the second flexible member comprises a toothed belt, a V-belt, a chain, a cable, or a drive coupling.

10. An antenna comprising:
a lens;
a feed trolley configured to couple to a feed;
a track coupled to the feed trolley;
a flexible member connected to the feed trolley configured to move the feed coupled to the feed trolley along the track to a first destination or to a second destination, wherein the feed is configured to move along the track to the first destination to form a first collimated beam through the lens to point to a first satellite, and wherein the feed is configured to move along the track to the second destination to form a second collimated beam through the lens to point to a second satellite.

11. The antenna of claim 10, further comprising an elevation drive motor configured to control the flexible member configured to move the feed coupled to the feed trolley to the first destination or to the second destination to facilitate a satellite handoff procedure, wherein the elevation drive motor is housed external to the feed trolley and the track.

12. The antenna of claim 10, wherein the first satellite is a setting satellite and the second satellite is a rising satellite.

13. The antenna of claim 10, wherein the flexible member comprises a toothed belt, a V-belt, a chain, a cable, or a drive coupling.

14. A user terminal (UT) comprising:
a control processor to provide one or more of the following functions for the UT:
signal processing, timing control/coordination, power control/coordination, handoff control/coordination, or selection of a frequency for use for signal carriers;
a digital data receiver coupled to the control processor to provide frequency or timing information to the control processor for a received signal being demodulated;
a digital transmit power controller coupled to the control processor to provide output power control for transmission of an output signal;
an antenna; and
a duplexer coupled to the digital data receiver and the digital transmit power controller to allow the antenna to serve both a transmit function and a receive function, wherein the antenna comprises:
a lens;
a first feed trolley configured to couple to a first feed, wherein the first feed is configured to form a first collimated beam through the lens in a first direction;
a second feed trolley configured to couple to a second feed, wherein the second feed is configured to form a second collimated beam through the lens in a second direction;
a track coupled to the first feed trolley and the second feed trolley, wherein the first feed coupled to the first feed trolley is configured to move along the track to a first destination to form the first collimated beam through the lens in the first direction and the second feed coupled to the second feed trolley is configured to move along the track to a second destination to form the second collimated beam through the lens in the second direction; and
a first flexible member connected to the first feed trolley configured to move the first feed coupled to the first feed trolley along the track, and a second flexible member connected to the second feed trolley configured to move the second feed coupled to the second feed trolley along the track.

15. The user terminal (UT) of claim 14, wherein the antenna further comprises a first elevation drive motor configured to control the first flexible member configured to move the first feed coupled to the first feed trolley along the track with respect to an elevation axis, and a second elevation drive motor configured to control the second flexible member configured to move the second feed coupled to the second feed trolley along the track with respect to the elevation axis, wherein the first elevation drive motor is housed external to the first feed trolley and the track, and the second elevation drive motor is housed external to the second feed trolley and the track.

16. The user terminal (UT) of claim 15, wherein the antenna further comprises a first side on the track configured to move the first feed along the track and a second side on the track configured to move the second feed along the track, wherein the first side and the second side are on opposite sides of the track.

17. The user terminal (UT) of claim 14, wherein the antenna further comprises:
an azimuth drive motor connected to the track, wherein the track is configured to rotate around a vertical axis to provide a second degree of freedom with respect to an elevation axis; and
a yoke connected to the track, wherein the track is configured to rotate around a tilt axis to provide a third degree of freedom with respect to the vertical axis and the elevation axis.

18. A user terminal (UT) comprising:
a control processor to provide one or more of the following functions for the UT:
signal processing, timing control/coordination, power control/coordination, handoff control/coordination, or selection of a frequency for use for signal carriers;
a digital data receiver coupled to the control processor to provide frequency or timing information to the control processor for a received signal being demodulated;
a digital transmit power controller coupled to the control processor to provide output power control for transmission of an output signal;
an antenna; and
a duplexer coupled to the digital data receiver and the digital transmit power controller to allow the antenna to serve both a transmit function and a receive function, wherein the antenna comprises:
a lens;
a feed trolley configured to couple to a feed;
a track coupled to the feed trolley;
a flexible member connected to the feed trolley configured to move the feed coupled to the feed trolley along the track to a first destination or to a second destination, wherein the feed is configured to move along the track to the first destination to form a first collimated beam through the lens to point to a first satellite, and wherein the feed is configured to move along the track to the second destination to form a second collimated beam through the lens to point to a second satellite.

19. The user terminal (UT) of claim 18, wherein the antenna further comprises an elevation drive motor configured to control the flexible member configured to move the feed coupled to the feed trolley to the first destination or to the second destination to facilitate a satellite handoff procedure, wherein the elevation drive motor is housed external to the feed trolley and the track.

20. The user terminal (UT) of claim 19, wherein the first satellite is a setting satellite and the second satellite is a rising satellite, and wherein the flexible member comprises a toothed belt, a V-belt, a chain, a cable, or a drive coupling.
